(19) United States
(12) Patent Application Publication
(10) Pub. No.: US 2006/0144977 A1
(43) Pub. Date: Jul. 6, 2006

(54) Disintegrator with power transmission apparatus, and use thereof

(75) Inventors: Tor Berdal, Sandvika (NO); Erik Holst Larsen, Asker (NO); Bernt Saugen, Lommedalen (NO)

Correspondence Address: RODMAN RODMAN, 7 SOUTH BROADWAY, WHITE PLAINS, NY, 10601, US

(73) Assignee: Tomra Systems ASA, Asker (NO)

(21) Appl. No.: 10/561,301

(22) PCT Filed: Jun. 17, 2004
(86) PCT No.: PCT/NO04/00178

§ 371 Date: Dec. 15, 2005

(30) Foreign Application Priority Data
Jun. 19, 2003 (NO) 20032814

(51) Int. Cl. B02C 19/00

(52) U.S. Cl. 241/73

(57) ABSTRACT

An apparatus for disintegrating articles of degradable or non-degradable material, wherein the apparatus has a rotatable knife unit (1) driven by a motor (2), wherein the knife unit blade (51) on rotation of the knife unit in a chamber (4) is designed to move along a chamber wall, and wherein at least a part of the wall has perforations (5). The knife unit (1) is driven by a motor (2) via a mechanical power transmission device (7) which is designed, in the event of a jamming of the knife unit in the chamber or a predetermined working resistance being exceeded, to cause at least partial disconnection of the transmission of power from the device to the knife unit. The power transmission device (7) comprises a flywheel (8) which, in said event of the knife unit jamming or working resistance being exceeded, is at least partly disconnected mechanically from the rotating mass of the knife unit. Operation of the knife unit (1) takes place by means of a motor (2) via the mechanical power transmission device (7) which comprises as part thereof a flywheel (8) and a centrifugal force based clutch mechanism (9) for sudden power engagement with coupling device (10) and thence with the knife unit (1) when the flywheel (8) reaches a predetermined rotational speed.

The present invention relates to an apparatus for disintegrating degradable or non-degradable material, wherein the apparatus has a functional unit in the form of a rotating knife unit driven by a motor via a mechanical power transmission device which comprises as part thereof a flywheel.

The invention also relates to an apparatus for transmitting power from a motor to a functional unit via a flywheel that is an integral part of a power transmission device.

Furthermore, the invention relates to the use of the apparatus.

There are already known many types of apparatus for disintegrating articles of degradable or non-degradable material, for example, in order to break up plastics material and metal into small pieces so as to prepare the material for further reuse, in circulation or energy recovery.

Apparatus of this type typically consist of a rotor which has a plurality of cutting blades mounted on its outer circumference, wherein the cutting edge of each blade extends parallel to the rotor axis. Each blade cuts against one or more fixed knives. A filtering screen made having a pattern of through holes is usually placed underneath the rotor and receives the cut fragments and allows them to pass out of the granulator when they have reached the appropriate size.

The lifetime costs of the existing disintegrating apparatus of this type prevent the implementation of such apparatus in recycling operations.

The object of the present invention is to provide a disintegrating apparatus that has substantially lower lifetime costs than the prior art apparatus. It is also an aim that the disintegrating apparatus provided by the invention should address the problems that can arise in the event of the rotor jamming or other provoked breakdown, for example, when foreign objects get into the cutting chamber and cause the rotor to come to a gradual or sudden halt. A further aim of the invention is in this way to prevent the knives and any counter-knives used and the rotor and rotor housing from being permanently damaged. Thus, it is an aim that the apparatus should be capable of being operative as soon as the foreign objects have been removed. As a rule, this has not been possible before.

According to the invention, the disintegrating apparatus mentioned above is characterised in that the functional unit has knife blades which on rotation in a chamber are designed to move along a chamber wall, wherein at least a part of the wall has perforations, and that the mechanical power transmission device comprises a mechanism in the form of a clutch that provides sudden power engagement with a coupling device and thence with the knife unit.

Further embodiments of this apparatus are disclosed in subsidiary claims 2-19.

The power transmission apparatus is characterised, according to the invention, in that the said power transmission device comprises as part thereof a mechanism in the form of a clutch which has means for sudden engagement with a coupling device, and wherein the clutch mechanism further forms a connection with the functional unit, and that said mechanism consists of one or more movable engagement blocks, which are mounted, spring-loaded, on a guide device.

Further embodiments of the power transmission apparatus are disclosed in subsidiary claims 21-28.

The use of the disintegrating apparatus and the power transmission apparatus is disclosed in detail in claims 29 and 30.

The invention will now be described in the form of an example with reference to the attached drawings.

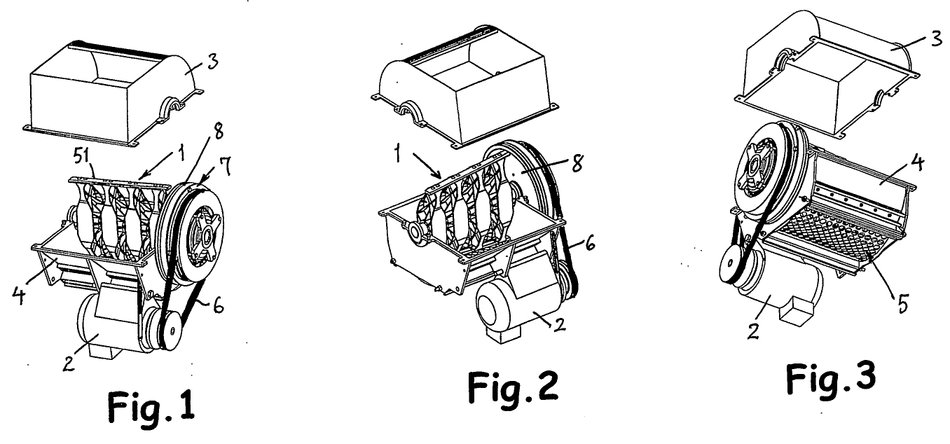

FIGS. 1 and 2 show the disintegrating apparatus seen from different sides and from above with a chamber cover removed to reveal details of the apparatus.

FIG. 3 shows the apparatus in FIG. 2 from below.

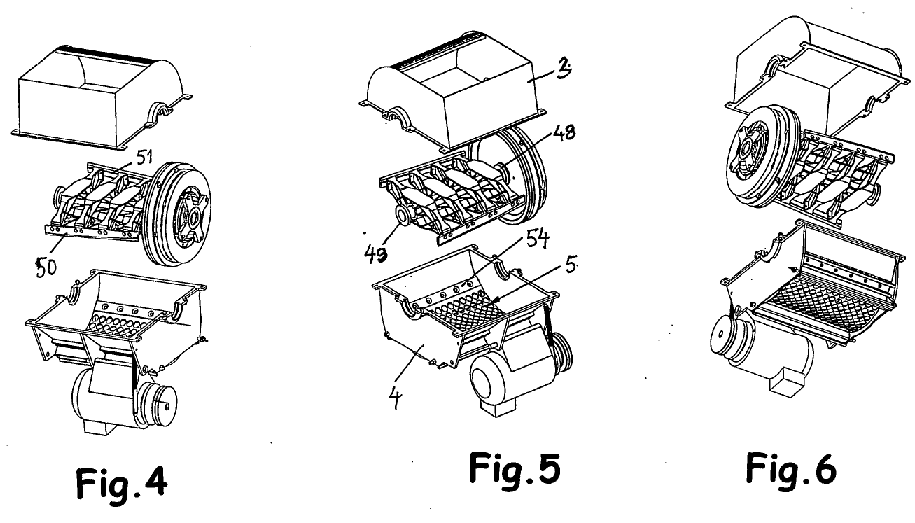

FIGS. 4, 5 and 6 are exploded drawings of that shown in FIGS. 1, 2 and 3 respectively.

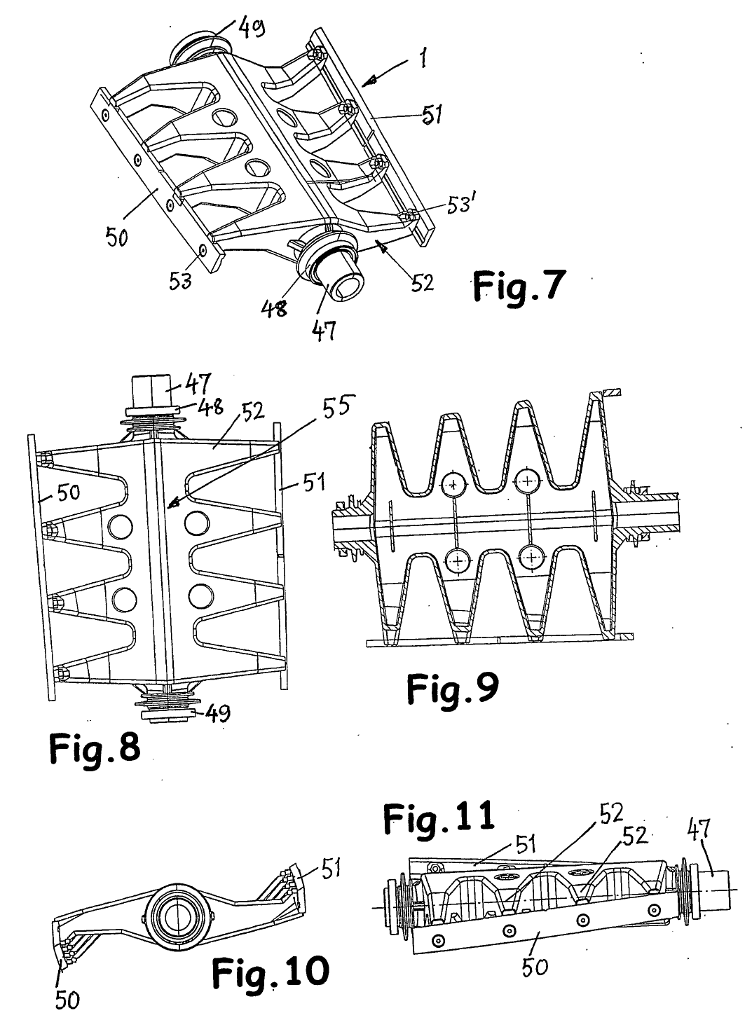

FIG. 7 shows a variant of a knife unit as shown in FIGS. 1-6.

FIGS. 8, 9, 10 and 11 are respectively a top view, a sectional view, an end view and a side view of the knife unit shown in FIG. 7.

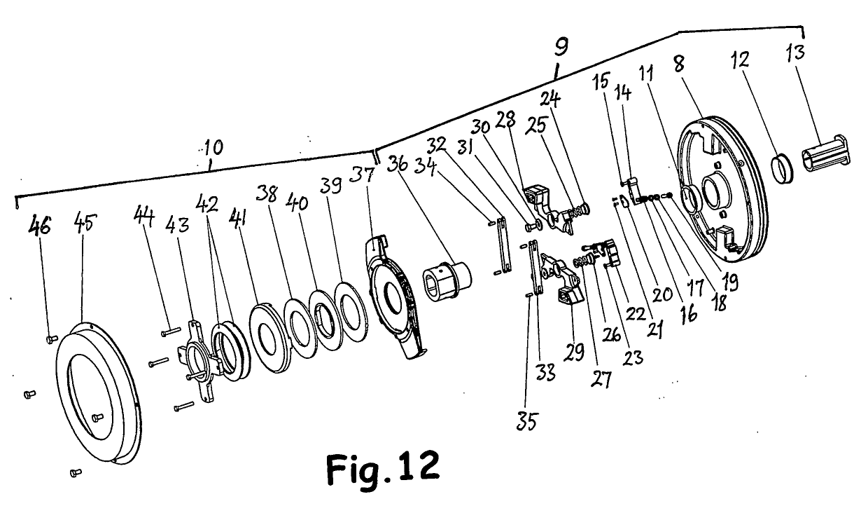

FIG. 12 show details of the power transmission apparatus.

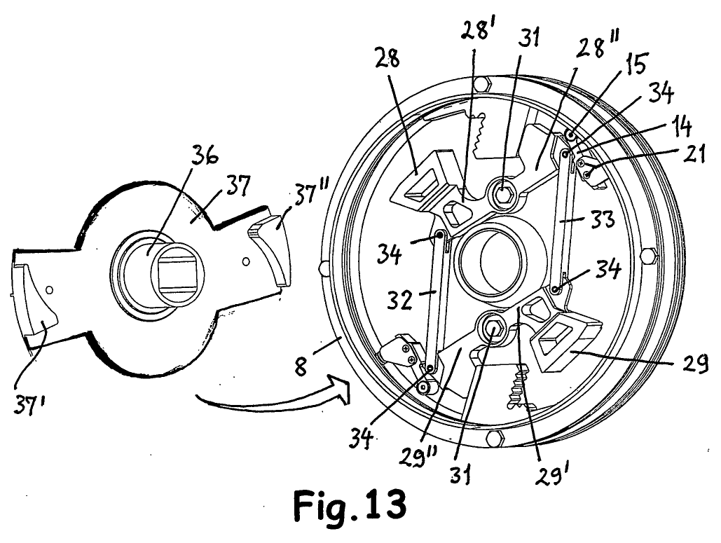

FIG. 13 shows details of the centrifugal part of the power transmission apparatus.

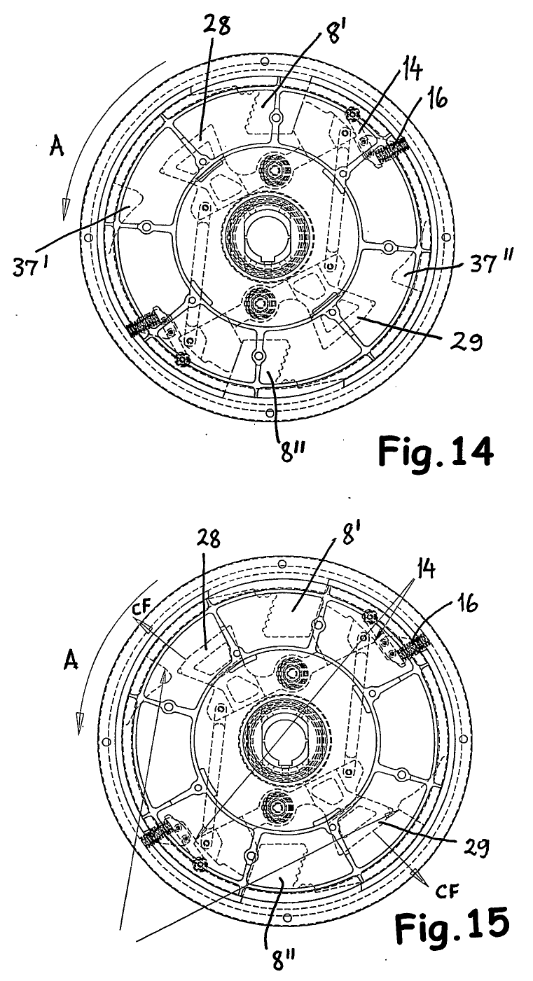

FIG. 14 shows the centrifugal part of the power transmission apparatus when disengaged.

FIG. 15 shows the centrifugal part of the power transmission apparatus close to engagement position.

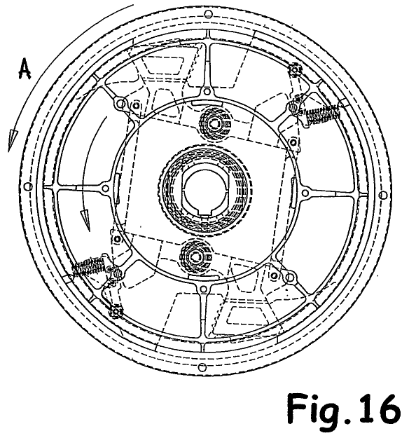

FIG. 16 shows the centrifugal part of the power transmission apparatus in centrifugally effected engagement.

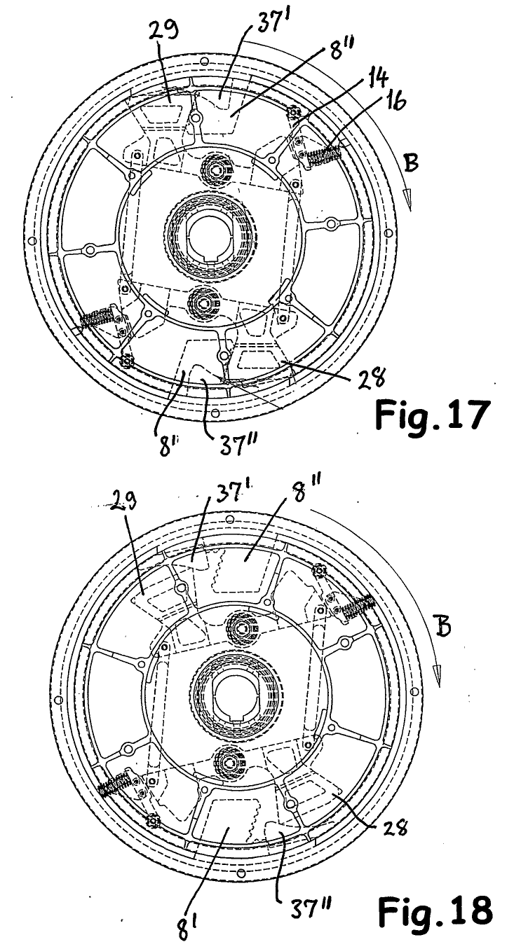

FIGS. 17 and 18 illustrate details of the centrifugal part of the power transmission apparatus for releasing the power transmission engagement.

FIGS. 1-6 show a rotating knife unit 1 that is driven by a motor 2 in a chamber formed of a top part 3 and a bottom part 4. As shown in FIGS. 3-6, at least a part of the wall of the chamber has perforations 5. The insert 1 can be driven by the motor 2, for example, by belt drive 6 and via a mechanical power transmission device 7, which will be described in more detail with reference to FIG. 12. The power transmission device 7 will be designed, in the event of the knife unit becoming jammed in the chamber or a predetermined working resistance being exceeded, to cause at least partial disconnection of transmission from the device 7 to the knife unit 1. Any damage to the knife unit 1 is thus substantially reduced. The power transmission device 7 has a flywheel 8 which will be arranged, in said event of the knife unit becoming jammed in the chamber or a predetermined working resistance being exceeded, to at least partially be disconnected from the mechanical power transmission to the rotating mass of the knife unit 1.

As will be explained in more detail in connection with FIG. 12 and FIGS. 13-18, there will be in connection with the power transmission device 7 and the flywheel 8 a centrifugal force based clutch mechanism 9 for sudden power engagement with a coupling device 10, as shown in more detail in FIG. 12. The knife unit will thus be brought into rotation as soon as the flywheel 8 reaches a predetermined rotational speed.

As shown and described in more detail in connection with FIGS. 17 and 18, the clutch mechanism is designed to be deactivated either by reversing the normal rotational direction of the motor 2 (see the arrow A in FIG. 14), or on cessation of the rotation of the flywheel, or in that the rotational speed of the flywheel falls below a predetermined disengagement threshold.

The individual components of the clutch mechanism 9 are shown in FIG. 12. This includes the said flywheel 8 and bearings 11, 12 which form the interface between the flywheel 8 and a shaft 36. Shaft adapter bushing 13 is for alternative mounting around a circular shaft with keyways. The reference numeral 14 indicates a release switch and the reference numeral 15 indicates a screw. The reference numerals 16, 17, 18 and 19 represent respectively a pressure spring, a pressure spring seat, a nut and a screw. The reference numeral 20 indicates a cover for the release spring 16, and the reference numeral 21 designates screws for securing this cover to the switch 14.

The reference numeral 22 indicates a release switch, like the switch 14, and the reference numeral 23 indicates a fastening screw for the same.

The reference numerals 24 and 26 indicate bearing parts and the reference numerals 25 and 27 are O-rings. The reference numerals 28 and 29 indicate a centrifugal slide and the references 30, 31 indicate a washer and a nut respectively. The parts 32, 33 are linkage rods and the references 34, 35 indicate fixing pins. The part 36 is a centrifugal shaft. The coupling device 10 includes a torque transfer piece 37. The reference numerals 38 and 39 indicate friction discs and the reference numeral 40 is a loose fitting brake disc. The disc 40 will engage with a peripheral portion of the centrifugal shaft 36. There is also provided a spring preload disc 41, disc springs 42 providing the said spring tension. A support 43 is provided for the disc springs 42 and the support 43 is mountable by means of screws 44. A safety cover 45 is provided and fastened to the flywheel 8 by screws 46.

The knife unit will have a pivot 47, see FIG. 7, which either is bolted to the shaft 36 or has a non-circular cross-section for direct engagement with the shaft 36.

At each end of the knife unit 1, as for instance shown in FIG. 7, bearings 48, 49 are provided. The knife unit knives 50, 51 are appropriately fastened to a plurality of arms 52 by a standard nut and screw connection, indicated by the reference numerals 53, 53′.

The engagement time of the clutch mechanism 9 will be adjustable as a function of the rotational speed of the flywheel. This can be done, for example, by adjusting the preloading of the spring 16 as shown in FIG. 12. Although a typical friction coupling with friction discs 38, 39 is shown in the coupling device, it will be understood that these discs together with the disc 40 could optionally form a slip coupling or free coupling, or a magnetic coupling as a result of modifications that are technically obvious per se once the total technical solution shown in FIG. 12 has been given. The efficiency of the coupling device can be adjustable by adjusting the preloading of the disc springs 42.

The centrifugal force based clutch mechanism 9 will be understood more clearly on perusing FIGS. 13-18. The object of the clutch mechanism is, when a certain rotational speed of the flywheel 8 is reached, to effect engagement between the flywheel 8 and the further mechanical transmission, such as the torque transmission piece 37, for further transmission to the knife unit 1 via the coupling device 10.

An important aspect of the present invention is that the rotational energy of the knife unit alone only accounts for 2-50% of the total rotational energy that is represented by the motor 2, the power transmission device 7, including the flywheel 8, and the actual knife unit 1. The point of making the rotational energy of the knife unit so low is to reduce damage to the knife unit in the event of the unit becoming jammed in the chamber or a predetermined working resistance being exceeded.

As shown in FIGS. 1-6, the blades of the knife unit are arranged essentially parallel to the rotational axis of the knife unit. However, it is conceivable that the knife unit blades, such as blades 50, 51 shown in FIGS. 7-11, may form a slight angle with the rotational axis of the knife unit when the knife unit is seen from above, as in FIG. 8. Similarly, an angle is formed with the rotational axis of the knife unit when the knife unit 1 is seen from the side, as in FIG. 11. Seen from the side, it will also be apparent from FIGS. 1, 2 and 4-6 that the knife unit blades 50, 51 form an angle with the rotational axis of the knife unit, so that the cutting edge of the knife blades 50, 51 gradually passes a cutting edge 54 in the chamber formed of the parts 3, 4. Through use of a nut and screw connection 53, 53′ as indicated in FIG. 7, the knife unit blades 50, 51 will be replaceable and/or adjustable.

As can be seen in particular from FIGS. 7, 8 and 11, the knife unit 1 has a hub 55 from which arms 52 project and wherein these arms at the outer end form a mount for the knife unit knives 50, 51.

As shown in, for example, FIGS. 7-11, the hub 55 and the arms 52 can be moulded in a single piece of a lightweight material, for example, aluminium or reinforced plastic. It is also conceivable that the hub 55 and the arms 52 may be formed of two moulded, identical and joinable parts of a lightweight material, for example aluminium or reinforced plastic, as will be understood more clearly on studying FIG. 9.

The clutch mechanism 9 may have one or more movable of the centrifugal slides 28, 29 that form engagement blocks and which, spring-loaded by a spring device 16 (FIG. 12), are mounted on a guide device consisting of the linkages 32, 33 and levers 28′, 28″ and 29′, 29″ mounted via bolts 31 so as to be capable of moving when the centrifugal force acting on the slides or the blocks 28, 29 exceeds the spring force exerted by the spring 16. In the illustrated case in FIG. 13, among others, the blocks 28, 29 will suddenly move radially outwards. In an envisaged alternative, springs could optionally be arranged between, for example, the part 28″ and the linkage 33, and also between the part 29″ and the linkage 32 in order, on the increasing rotational speed of the flywheel, to allow the blocks 28 and 29 to gradually move radially outwards. On predetermined rotational speed, whatever the solution, the blocks will engage with cam-shaped engagement means 37′, 37″, for example, blocks, on the rotating part 37. The rotating part 37 may be designed as shown in FIGS. 12 and 13, or is optionally made of a circular plate structure that is a part of the power transmission device for further connection to the functional unit. At the same time, it will be seen that the blocks 28, 29 also come to rest against blocks 8′, 8″ on the flywheel, so that in reality there is a direct load transfer between the block 8′, the block 28 and the engagement means 37′, or the block 8″, the block 29 and the engagement means 37″. Thus, in reality there is no physical moment-induced load on the arm members 28′, 28″, 29′, 29″ and the linkages 32, 33.

FIG. 14 shows the position of the blocks 28, 29 before the blocks are released and are able to move outwards for engagement.

FIG. 15 shows the blocks in a position immediately before the retention mechanism formed by, inter alia, the spring 16 is released, so that the blocks 28, 29 can suddenly move outwards.

FIG. 16 shows the blocks 28, 29 in engagement position and where the release mechanisms are represented by the spring 16, and the linkage 14, 22 has become disengaged from an end portion of the respective parts 28″, 29″.

In the event of jamming or in the event of a desire to allow the functional unit, for example, the knife unit 1, to become disengaged from the drive mechanism via the flywheel 8, the flywheel 8 is made to rotate in the opposite direction as indicated by the arrow B in FIG. 17.

FIG. 18 shows how the blocks 28, 29 are about to return to the starting position as shown in FIG. 14. As previously mentioned, the blades 50, 51 on the knife unit 1 shown in the figures are intended, on rotation along the chamber wall, to move past at least one counter-knife 54 mounted on the chamber wall. In a preferred embodiment of the invention, the position of the counter-knife will be adjustable and the counter-knife 54 will optionally also be replaceable.

If the functional unit according to the invention consists of a disintegrator as described by way of example, it could be suitable for disintegrating articles made of, for instance, plastics material, glass, light metal or thin metal.

Alternatively, the disintegrator may be suitable for disintegrating articles consisting of packaging in the form of bottles, cans, beverage cartons, trays or boxes, and optional disintegration of accessories for such packaging.

It is also conceivable that the disintegrator could be used for disintegrating articles of biologically, degradable material from: wood, plants, plant debris, paperboard, starch-based material and cellulose-based material.

In a preferred use, the apparatus including the disintegrator can be used in an installation or device, for example, a reverse vending machine, for handling or processing packaging for stimulants and foods, for example, packaging such as bottles, cans, trays, boxes and beverage cartons.

Although the functional unit in the present description has been described exclusively as a disintegrator, as shown in, for example, FIGS. 1-6, the functional unit may however consist of other solutions where rotation of functional parts is involved, and where a power transmission apparatus as shown and described in connection with FIGS. 12-18 is especially involved with the addition of a motor drive.

1. An apparatus for disintegrating degradable or non-degradable material, wherein the apparatus has a functional unit in the form of a rotatable knife unit driven by a motor (2) via a mechanical power transmission device (7) which comprises as part thereof a flywheel (8),
characterised in
that the functional unit has knife blade (51) which on rotation in a chamber (4) is designed to move along a chamber wall, wherein at least a part of the wall has perforations; and
that the mechanical power transmission device (7) comprises a mechanism in the form of a clutch (9) which provides sudden power engagement with coupling device (10) and thence with the knife unit (1).

2. An apparatus as disclosed in claim 1, characterised in
that the power engagement takes place when the flywheel (8) in the mechanism reaches a predetermined rotational speed.

3. An apparatus as disclosed in claim 1 or 2, characterised in
that said mechanism is designed, in the event of the functional unit jamming or a predetermined working resistance being exceeded, to be deactivated by at least partial disconnection of the transmission of power from the power transmission device to the rotational mass of the knife unit.

4. An apparatus as disclosed in claim 1, 2 or 3, characterised in
that the mechanism is centrifugal force controlled.

5. An apparatus as disclosed in claim 3 or 4, characterised in
that the mechanism is designed to be deactivated either by reversing the normal rotational direction of the motor, or on cessation of the rotation of the flywheel, or in that the rotational speed of the flywheel is below a predetermined disengagement threshold.

6. An apparatus as disclosed in claim 1, 2, 3, 4 or 5, characterised in
that the engagement time of the mechanism as a function of the rotational speed of the flywheel is adjustable.

7. An apparatus as disclosed in one or more of claims 1-6, characterised in
that the coupling device consists of an adjustable slip coupling.

8. An apparatus as disclosed in one or more of the preceding claims, characterised in
that the mechanism is designed, when a certain rotational speed of the flywheel has been reached, to cause a sudden engagement between the flywheel and the further mechanical transmission to the functional unit via the coupling device.

9. An apparatus as disclosed in one or more of the preceding claims, characterised in
that the rotational energy of the functional unit alone accounts for 2-50% of the total rotational energy represented by the motor, the power transmission device including the flywheel, and the knife unit.

10. An apparatus as disclosed in one or more of the preceding claims, characterised in
that said knife blade forms an angle with the rotational axis of the functional unit.

11. An apparatus as disclosed in one of more of the preceding claims, characterised in
that said knife blade is replaceable and/or adjustable.

12. An apparatus as disclosed in one or more of the preceding claims, characterised in
that the functional unit consists of a hub from which arms project, which at their outer end form a mount for said knife blade.

13. An apparatus as disclosed in claim 12, characterised in
that the hub and the arms are moulded in a single piece of a lightweight material, e.g., aluminium or reinforced plastic.

14. An apparatus as disclosed in claim 12, characterised in
that the hub and the arms are formed of two moulded, identical, joinable parts of a lightweight material, e.g., aluminium or reinforced plastic.

15. An apparatus as disclosed in one or more of claims 1-14, characterised in
that the mechanism comprises one or more movable, spring-loaded engagement blocks which are mounted on a guide device (28′, 28″, 29′, 29″, 32, 33); and
that the block or blocks are designed, through centrifugal force during the increasing rotation of the flywheel, to move radially outwards either gradually or suddenly, and on said predetermined rotational speed, to engage with engagement means, e.g., a block or blocks on a rotating part (37) of the coupling device, e.g., a rotating plate, which forms a further connection to the functional unit.

16. An apparatus as disclosed in one or more of the preceding claims, characterised in
that said knife blade is designed on rotation along the chamber wall to move past at least one counter-knife (54) mounted on the chamber wall.

17. An apparatus as disclosed in claim 16, characterised in
that the position of the counter-knife is adjustable.

18. An apparatus as disclosed in claim 15, wherein at least one pair of blocks is used, characterised in
that the guide device consists of an articulated arm device common to the pair of blocks whose articulated arms are pivotally fastened to the flywheel.

19. An apparatus as disclosed in claim 15, characterised in
that there is provided at least one pair of diametrically arranged engagement blocks.

20. An apparatus for the transmission of power from a motor (2) to a functional unit (1) via a flywheel (8) which forms a part of a power transmission device (7), characterised in
that the transmission device (7) comprises as part thereof a mechanism (9) in the form of a clutch (9) which has means for sudden power engagement with a coupling device (10), and wherein the clutch mechanism (9) forms further connection with the functional unit; and
that said mechanism (9) consists of one or more movable engagement blocks (28, 29), which, spring-loaded, are mounted on a guide device (28′, 28″, 29′, 29″, 32, 33).

21. An apparatus as disclosed in claim 20, characterised in
that power transmission to the functional unit (1, 4) is designed to take place when the rotational speed of the flywheel (8) passes a defined threshold value; and
that the block or blocks are designed, through centrifugal force during the increasing rotational speed of the flywheel, to move radially outwards either gradually or suddenly, and on said predetermined rotational speed, to engage with engagement means (37′, 37″), e.g., a block or blocks on a rotating part (37) of the coupling device (10), e.g., a rotating plate, which is a part of the power transmission device (7) and which forms further connection to the functional unit (1).

22. An apparatus as disclosed in claim 21, characterised in
that said mechanism is deactivatable either by reversing the normal rotational direction of the motor, or on cessation of the rotation of the flywheel, or in that the rotational speed of the flywheel is below a predetermined threshold value.

23. An apparatus as disclosed in claim 20, 21 or 22, characterised in
that the engagement time of the mechanism is adjustable as a function of the rotational speed of the flywheel.

24. An apparatus as disclosed in claim 20, wherein at least one pair of blocks is used, characterised in
that the guide device consists of an articulated arm device common to the pair of blocks whose articulated arms are pivotally connected to the flywheel.

25. An apparatus as disclosed in claim 20, characterised in
that there is provided at least one pair of diametrically arranged engagement blocks.

26. An apparatus as disclosed in one or more of claims 20-25, characterised in
that the coupling device comprises an adjustable slip coupling.

27. An apparatus as disclosed in one or more of claims 20-26, characterised in
that the mechanical transmission engagement or disengagement of the flywheel is centrifugal force based.

28. An apparatus as disclosed in one or more of claims 20-27, characterised in
that the power transmission device is designed, in the event of a predetermined working resistance being exceeded, to cause at least partial deactivation of said mechanism for disconnection of power transmission from the device to the functional unit;
that said deactivation involves the flywheel with its rotational energy being mechanically disconnected from the coupling device; and
that said disconnection of the rotational energy of the flywheel is centrifugal force controlled.

29. Use of an apparatus as disclosed in one or more of claims 1-28 in order, with the aid of said motor-driven functional unit, to disintegrate or compact articles selected from the group consisting of:
a) articles in the form of packaging, for example, bottles, cans, beverage cartons, trays or boxes, and accessories for same;
b) articles made of plastics material, glass, light metal or thin metal, e.g., tin;
c) articles of biologically degradable material, for instance, wood, plants, plant debris, paperboard, starch-based material and cellulose-based material;
d) packaging of biologically degradable material selected from paperboard, starch-based material and cellulose-based material.

30. A use as disclosed in claim 29, for handling or processing articles in a reverse vending machine.
